(19) United States
(12) Patent Application Publication
(10) Pub. No.: US 2011/0203159 A1
(43) Pub. Date: Aug. 25, 2011

(54) CHEMICAL LURE COMPOSITION, APPARATUS, AND METHOD FOR TRAPPING BED BUGS

(75) Inventor: Susan McKnight, West Hartford, CT (US)

(73) Assignee: Susan McKnight, Inc., Memphis, TN (US)

(21) Appl. No.: 13/096,468

(22) Filed: Apr. 28, 2011

Related U.S. Application Data
(63) Continuation-in-part of application No. 12/327,856, filed on Dec. 4, 2008.
(60) Provisional application No. 61/329,961, filed on Apr. 30, 2010.

(51) Int. Cl. A01M 1/10; A01N 25/00

(52) U.S. Cl. 43/123; 424/84

(57) ABSTRACT

A method for attracting bed bugs includes placing a climb-up pitfall trap apparatus that includes a chemical lure composition. The lure composition includes a combination of (a) L-lactic acid, and (b) at least one fatty acid or salt selected from the group consisting of (1) propionic acid, (2) butyric acid, and (3) valeric acid, and (c) 1-octen-3-ol, and (d) a suitable ketone, and (e) a suitable aliphatic sulfide. The trap may also include in conjunction with the lure composition a carbon dioxide source and/or a heat source to compose a lure arrangement.

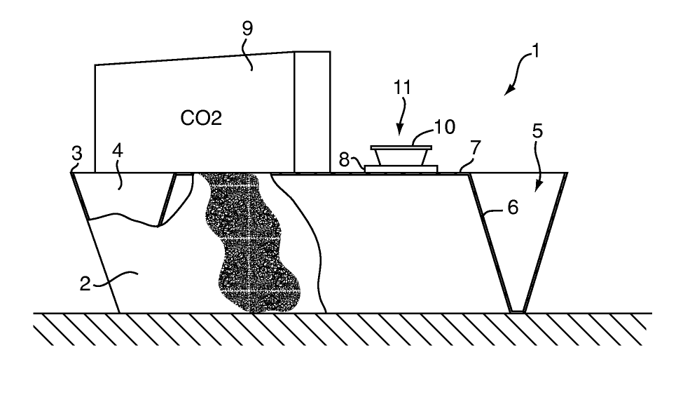

### CROSS-REFERENCE TO RELATED APPLICATION

This application claims the benefit of U.S. Provisional Application No. 61/329,961, filed Apr. 30, 2010, hereby incorporated herein by reference. This application also is a continuation-in-part of U.S. patent application Ser. No. 12/327,856 by McKnight, filed Dec. 4, 2008, hereby incorporated herein by reference.

### FIELD OF THE INVENTION

The invention relates to trapping insects. More particularly, embodiments of the invention relate to bed bug traps including chemical lures.

### BACKGROUND OF THE INVENTION

The bed bug, Cimex lectularius, is a small crawling blood-sucking insect that feeds on human, bird and bat blood. The tropical bed bug, Cimex hemipterus, is very similar to Cimex lectularius both in behavior and appearance and was confined to tropical regions until the advent of central heating in buildings in temperate climates but now is found throughout temperate zones. In the 1940s and 1950s, the widespread use of DDT and other residual pesticides caused a drastic decline in the bed bug population. However, bed bugs have developed resistances to these chemicals and are a rising threat to the commercial health of resort hotels, apartments, college dormitories, cruise ships and airplanes.

One approach to capturing insects has been the use of pitfall traps. The essential components of a pitfall trap are a container or pit and an interior wall that cannot be climbed. For example, a bug that falls into the trap will be unable to escape because it cannot climb up the interior wall, and is captured. Rough surfaces are easily climbed by bed bugs. Using their hook-like tarsal claws to engage fibres and surface roughness, bed bugs are capable of navigating vertical surfaces, for example, the underside of beds and even the human body. In fact, bed bugs exhibit behavior that seems to favor climbing inclined surfaces. In contrast, smooth surfaces can prove insurmountable and may even repel bed bugs. Smooth, hard surfaces can be made from glass, ceramics, metals, finished treatments on polished wood, finished treatments on paper, plastics and polymers. Insect and arthropod pitfall traps are known in the art, for example, U.S. Pat. No. 6,860,062 to Spragins discloses an adapted outdoor pitfall trap for crawling and flying insects; and U.S. Pat. No. 4,608,774 to Sherman discloses an indoor pitfall trap for cockroaches. A climb-up pitfall trap for bed bugs and the like comprised of a rough exterior surface serving as an upward climbing wall, a precipice lining the inside edge of the exterior surface, and a smooth interior surface receptacle is disclosed in U.S. patent application 20090145020 by McKnight.

Another approach to capturing insects is the use of sensory lures. Bed bugs are attracted to chemical signals emitted by the hosts upon which they feed. Such chemical signals take the form of odor molecules, which drift away from the source by diffusion and by being carried in an air flow.

One chemical attractant is carbon dioxide, which is given off by respiring animals. Carbon dioxide is a ubiquitous gas in the atmosphere, with normal ambient background outdoor levels of 300 to 400 p.p.m. For example, normal adult human respiration expires around 200 ml/min of carbon dioxide, at a concentration of 45,000 p.p.m. in the expired air. Insects and arthropods that feed on host organisms are sometimes attracted to the increased carbon dioxide levels that are created by and thus surround the host. For example, tsetse flies and yellow fever mosquitoes are attracted by increased carbon dioxide levels over the ambient environment; blood-sucking conenose bugs are attracted by carbon dioxide levels between 300 and 400 p.p.m. over ambient levels; and mosquitoes are attracted linearly by carbon dioxide release rates up to 1,000 ml/min. Bed bugs are likewise attracted by carbon dioxide levels above ambient level.

Another chemical attractant detected by the olfactory senses of insects is an odor molecule such as L-lactic acid. L-lactic acid is a volatile component of human sweat that ranges in concentration from 0.5 to 5.0 mg/l. In some blood-sucking arthropods, L-lactic acid, when presented as a single stimulus, has only a slight or non-attractive effect. But when presented with carbon dioxide, L-lactic acid acts as a synergist and increases the attractiveness of the gas. The use of lactic acid as an attractant is known in the art, for example, U.S. Pat. No. 4,907,366 to Balfour discloses a trap for attracting mosquitoes using a composition consisting of lactic acid, carbon dioxide, water and heat.

Other chemical attractant odor molecules are the group of chemicals known as fatty acids, and, in particular, short chain fatty acids. Fatty acids are a volatile compound that include, but are not limited to, compounds such as acetic, propionic, isobutyric, butyric, isovaleric and valeric acids, all of which are present in human waste. The use of fatty acids as an attractant is known in the art, for example, Japan Patent No. JP-A-59062504 to Yasushi discloses an attractant composition for non-bloodsucking onion flies consisting of propionic acid, n-butyric acid, isobutyric acid, n-valeric acid, isovaleric acid, isocaprionic acid and 2-phenylethanol. See, also, U.S. Pat. No. 4,818,526 to Wilson and U.S. Pat. No. 5,258,176 to Keenan.

Another such attractant odor molecule is 1-Octen-3-ol (octenol). Octenol is a volatile component of cattle and human breath and sweat. Octenol is a potent olfactory attractant for tsetse flies and some mosquito species when combined with increased levels of carbon dioxide; for blood-sucking conenose bugs even at ambient carbon dioxide levels; and for mosquitoes, some of which are synergistically attracted by octenol and increased levels of carbon dioxide together. Others are attracted by octenol at ambient carbon dioxide levels. Bed bugs are attracted by octenol, but octenol is not an essential element in attracting bed bugs as evidenced by the fact that octenol is not emitted by birds, one of the other hosts of bed bugs. The use of carbon dioxide and/or octenol as an attractant of mosquitoes, no-see-ums, biting flies and ticks is known in the art from, for example, U.S. Pat. No. 5,205,064 to Nolen, U.S. Pat. No. 5,382,422 to Dieguez, U.S. Pat. No. 5,799,436 to Nolen, U.S. Pat. No. 6,055,766 to Nolen, U.S. Pat. No. 6,145,243 to Wigton, U.S. Pat. No. 6,199,316 to Coventry, U.S. Pat. No. 6,305,122 to Iwao, U.S. Pat. No. 6,516,559 to Simchoni, published U.S. Patent Application No. 2004/0025412 to Simchoni, U.S. Pat. No. 6,718,687 to Robison, U.S. Pat. No. 6,898,896 to McBride, U.S. Pat. No. 7,074,830 to Durand, U.S. Pat. No. 7,243,458 to Miller, U.S. Pat. No. 5,189,830 to Montemurro, and European Patent No. 1745697 to Geier.

Other such attractant odor molecules are carbon disulfide and ketones. U.S. Pat. No. 4,818,526 to Wilson discloses the use of dimethyl disulfide and dibutyle succinate and combinations thereof as attractants for mosquitoes. U.S. Pat. No. 6,267,953 to Bernier et al. discloses the use of lactic acid with dimethyl disulfide and acetone. U.S. Pat. No. 6,800,279 to Bernier et al. discloses the use of lactic acid with carbon disulfide and with butanone, 2-pentanone or acetone.

Attractant chemical odor molecules can take on many forms and combinations. See, for example, European Patent No. WO 9826661 to Justus, U.S. Pat. No. 5,900,244 to Howes, U.S. Pat. No. 6,106,821 to Baker, U.S. Pat. No. 6,593,299 to Bennett, U.S. Pat. No. 6,800,279 to Bernier, U.S. Pat. No. 6,866,858 to Nolen, and U.S. Pat. No. 6,920,716 to Kollars.

Insect response to olfactory sensory neuron stimulation is dose dependent. For instance, the same compound may repel at one concentration and attract at another concentration.

The combination of highly effective chemical attractants with efficient traps allows for an improved control method to be developed. However, as is clear from the diversity of prior art, it is not possible to predict which compounds at which dosage levels will be effective attractants of a particular insect species. Accordingly, an effective a lure composition for attracting bed bugs and the like, and a method for monitoring bed bugs and the like is herein disclosed.

### SUMMARY OF THE INVENTION

Various embodiments of the present invention provide a lure composition, lure arrangement, and/or method for attracting and capturing bed bugs and the like. In some embodiments, the present invention combines a collection structure with a chemical lure composition that has improved efficacy due to a synergistic combination of elements. In some embodiments, an improved chemical lure includes non-toxic agents that render insects more susceptible to the selected attractants. In embodiments of the present invention, the pre-selected insect population includes bed bugs. Thus, the present invention reduces use of sprayed or broadcast attractants.

In embodiments of one aspect of the invention, a lure composition for attracting bed bugs and the like is provided. The lure composition comprises a combination of (a) L-lactic acid or salt thereof, (b) 1-octen-3-ol, and surprisingly small amounts of (c) propionic acid, butyric acid, valeric acid, or one of the salts thereof. In some embodiments, the lure composition may also comprise (d) acetone, and/or (e) dimethyl disulfide.

In embodiments of a second aspect of the invention, a lure arrangement for attracting bed bugs and the like is provided. The lure arrangement comprises a heat source, a carbon dioxide source, and a lure composition. The lure composition comprises a combination of (a) L-lactic acid or salt thereof, (b) 1-octen-3-ol, and surprisingly small amounts of (c) propionic acid, butyric acid, valeric acid, or one of the salts thereof. In some embodiments, the lure composition may also comprise (d) acetone, and/or (e) dimethyl disulfide.

In embodiments of a third aspect of the invention, a lured trap is provided. The trap includes a climb-up pitfall structure in which a lure composition is disposed. The trap may also include a heat source, and a carbon dioxide source, which together with the lure composition form a lure arrangement associated with the trap.

According to a fourth aspect of the invention, bed bugs are trapped by providing a lure composition within a climb-up pitfall trap, and positioning the lured trap in an infested environment. The lured trap may further be provided with a lure arrangement, which may be activated to produce gaseous vapors enhancing the effect of the lure composition.

### BRIEF DESCRIPTION OF THE DRAWING FIGURE

The drawing FIGURE shows a climbable pitfall type trap, as may be usable with lure compositions according to various embodiments of the invention.

### DETAILED DESCRIPTION OF EMBODIMENTS

According to embodiments of the invention, a lure composition is a composition for attracting bed bugs and may include a combination of (a) L-lactic acid or salt thereof, (b) 1-octen-3-ol, and surprisingly small amounts of at least one of (c) propionic acid, butyric acid, valeric acid, or one of the salts thereof. In some embodiments, the lure composition may also include (d) acetone, and/or (e) dimethyl disulfide.

A preferred lure composition includes bed bug attracting amounts of L-lactic acid. L-lactic acid (CAS #50-21-5) is a carboxylic acid with a chemical formula of C.sub.3H.sub.6O.sub.3. L-lactic acid has a hydroxyl group adjacent to the carboxyl group, making it an alpha hydroxy acid (AHA). In solution, L-lactic acid can lose a proton from the acidic group, producing the lactate ion CH.sub.3CH(OH)COO—.

Lactic acid is chiral and has two optical isomers. One is known as L-(+)-lactic acid or (S)-lactic acid and the other, a mirror image, is D-(−)-lactic acid or (R)-lactic acid. L-(+)-Lactic acid is the biologically important isomer used in the present invention. L-lactic acid is also called (+)-Lactic acid, (.+-.)-2-Hydroxypropanoic acid, (.+-.)-Lactic acid, (R)-2-hydroxypropanate, (R)-lactate, (RS)-2-Hydroxypropionsaeure, (S)-(+)-Lactic acid, (S)-2-Hydroxypropanoic acid, (S)-2-Hydroxypropionic acid, (S)-2-Hydroxypropionsaeure, (S)-lactate, (S)-Lactic acid, (S)-Milchsaeure, 1-Hydroxyethanecarboxylic acid, 10326-41-7, 152-36-3, 1715-99-7, 2-Hydroxy-2-methylacetic acid, 2-hydroxy-propionic acid, 2-hydroxypropanoic acid, 2-hydroxypropionic acid, 26100-51-6, 28305-25-1, 29870-99-3, 31587-11-8, 4-03-00-00633 (Beilstein Handbook Reference), 50-21-5, 598-82-3, 72-17-3, 79-33-4, 814-81-3, Acidum lacticum, Acidum sarcolacticum, Aethylidenmilchsaeure, Al3-03130, alpha-Hydroxypropanoic acid, alpha-Hydroxypropionic acid, Biolac, BRN 1720251, BRN 5238667, C01432, CCRIS 2951, CHEBI:28358, Chem-Cast, Cop-per lactate (ic), Copper lactate Cu(O3H5C3)2, D-LACTATE, D00111, DL-Lactic acid, DL-Milchsaeure, E 270, EINECS 200-018-0, EINECS 201-196-2, EINECS 209-954-4, EPA Pesticide Chemical Code 128929, Espiritin, Ethylidenelactic acid, FEMA No. 2611, FEMA Number 2611, Fleischmilchsaeure, HSDB 800, Indium lactate, Kyselina 2-hydroxypropanova [Czech], Kyselina mlecna [Czech], L( )2-Hydroxypropionsaeure, L(+)-lactate, L-(+)-alpha-Hydroxypropionic acid, l-(+)-Lactic acid, L-LACTATE, L-Lactic acid, lac, Lacolin, Lactacyd, lactasol, lactate, Lactate (TN), lactic acid, Lactic acid (7Cl,8Cl), Lactic acid (JP14/USP), Lactic acid (natural), Lactic acid monosodium salt, Lactic acid USP, Lactic acid [JAN], Lactic acid, calcium salt (2:1), L-, Lactic acid, copper (2+) salt (2:1), Lactic acid, L-, Lactic acid, monosodium salt, Lactic acid, sodium salt, Lactic acid, strontium salt (2:1), Lactovagan, LMFA01050002, LS-180647, LS-2145, Milchsaeure, Milchsaure [German], Milk acid, Monosodium lactate, NCIOpen2.sub.--000884, NSC 367919, NSC112239, NSC112240, NSC112243, NSC122003, NSC31718, NSC367919, NSC370148, NSC77164, NSC97377, Ordinary lactic acid, Paralactic acid, Paramilchsaeure, Per-glycerin, PH 90, Poly(lactic acid), Polylactic acid, Propanoic acid, 2-hydroxy-, Propanoic acid, 2-hydroxy-(9Cl), Propanoic acid, 2-hydroxy-, (.+-.), Propanoic acid, 2-hydroxy-, (.+-.)-, homopolymer, PROPANOIC ACID, 2-HYDROXY-, (. . . +- . . . )-, Propanoic acid, 2-hydroxy-, (2S)-, PROPANOIC ACID, 2-HYDROXY-, (S)-, Propanoic acid, 2-hydroxy-, (S)-(9Cl), Propanoic acid, 2-hydroxy-, calcium salt (2:1), (S)-, Propanoic acid, 2-hydroxy-, homopolymer, Propanoic acid, 2-hydroxy-, monosodium salt, Propanoic acid, 2-hydroxy-, strontium salt (2:1), Propanoic acid, 2-hydroxy-, (. . . +- . . . )-, Propel, Propionic acid, 2-hydroxy-, PURAC, Purac FCC 88, PYR, Pyruvic Acid, Racemic lactic acid, Sarcolactic acid, Sodium .alpha.-hydroxypropionate, Sodium lactate, Sodium lactate, injection, Sodium lactic acid, Strontium lactate, SY-83, Tisulac and Tonsillosan.

In some embodiments, the lure composition may also include bed bug attracting amounts of propionic acid. Propionic acid (CAS #79-09-4) is a volatile fatty acid, CH.sub.3CH.sub.2COOH. Prepared synthetically from ethyl alcohol and carbon monoxide, propionic acid is used chiefly in the form of its propionates. Propionic acid is also called propanoic acid, metacetonic acid, methylacetic acid carboxyethane, hydroacrylic acid, ethylformic acid, ethanecarboxylic acid, 1/C3H6O2/c1-2-5-3-4/h3H,2H2,1H, 109-94-4, Aethylformiat, Aethylformiat [German], Al3-00407, Areginal, Carboxylic acid oxaethane, Caswell No. 443A, EINECS 203-721-0, EPA Pesticide Chemical Code 043102, Ethyl formate, Ethyl formate (natural), Ethyl formate [UN1190] [Flammable liquid], Ethyl formic ester, Ethyl methanoate, Ethyle (formiate d′) [French], Ethyle (formiate d′) (FRENCH), Ethylester kyseliny mravenci [Czech], Ethylformiaat, Ethylformiaat [Dutch], Etile (formiato di) [Italian], Etile (formiato di) (ITALIAN), FEMA No. 2434, FEMA Number 2434, Formic acid, ethyl ester, FORMIC ACID, ETHYL ESTER, Formic ether, HSDB 943, Mrowczan etylu, Mrowczan etylu [Polish], NSC 406578, NSC406578, NSC8828, UN1190 and ZINC01648253.

In some embodiments, the lure composition may also include bed bug attracting amounts of butyric acid. Butyric acid (CAS #107-92-6) is either of two colorless isomeric volatile fatty acids, CH.sub.3CH.sub.2CH.sub.2COOH. Butyric acid is also called 1-Butyric acid, 1-propanecarboxylic acid, 1/C.sub.4H.sub.8O.sub.2/c1-2-3-4(5)6/h.sub.2-3H.sub.2,1H.sub.3,(H,5,6, 107-92-6, 156-54-7, 2-butanoate, 4-02-00-00779 (Beilstein Handbook Reference), 5434-68-4, Al3-15306, AIDS-096140, AIDS096140, BEO, Bio1.sub.-000444, Bio1.sub.--000933, Bio1.sub.--001422, BRN 0906770, BUA, Butanic acid, butanoate, butanoic acid, Butanoic acid, nickel (2+) salt, Butanoic acid, sodium salt, butoic acid, Buttersaeure, Buttersaeure [German], butyrate, Butyrate sodium, Butyrate, sodium salt, Butyric acid (natural), Butyric acid [UN2820] [Corrosive], Butyric acid [UN2820] [Corrosive], Butyric acid, nickel(II) salt, Butyric acid, sodium salt, C00246, CCRIS 6552, CH3-[CH2]2-COOH, CHEBI:30772, EINECS 203-532-3, ethylacetic acid, FEMA No. 2221, FEMA Number 2221, HSDB 940, IMET 3393, Kyselina maselna [Czech], LMFA01010004, LS-443, n-Butanoic acid, n-Butyric acid, NCI60.sub.-001424, NCIMech.sub.-000707, NSC 8415, NSC174280, NSC7701, NSC8415, propylformic acid, Sodium butanoate, Sodium butyrate, Sodium n-butyrate and UN2820.

In some embodiments, the lure composition includes bed bug attracting amounts of valeric acid. Valeric acid (CAS #109-52-4) is a volatile fatty acid, CH.sub.3CH.sub.2CH.sub.2 CH.sub.2COOH. Valeric acid is also called 1-Butanecarboxylic acid, 1/C.sub.5H.sub.10O.sub.2/c1-2-3-4-5(6)7/h2-4H.sub.2,1H.sub.3,(H,6,7, 109-52-4, 12124-87-7, 19455-21-1, 4-02-00-00868 (Beilstein Handbook Reference), 42739-38-8, 5434-69-5, 556-38-7, 56767-12-5, 6106-41-8, 70268-41-6, A13-08657, AIDS-017600, AIDS017600, BRN 0969454, Butanecarboxylic acid, C00803, CH3-[CH2]3-COOH, CHEBI:17418, EINECS 203-677-2, FEMA No. 3101, HSDB 5390, Kyselina valerova [Czech], LAEVULINIC ACID, LEA, LEVULINIC ACID, LMFA01010005, LS-3150, n-Pentanoate, n-Pentanoic acid, n-Valeric acid, NSC 406833, NSC122828, NSC406833, NSC7702, PEI, Pentanic acid, Pentanoate, Pentanoic acid, Pentanoic acid Valeric acid, Pentanoic acid, nickel (2+) salt, pentoic acid, Propylacetic acid, SHF, Valerate, Valerianic acid, Valeriansaeure, Valeric acid, VALERIC ACID, N-, Valeric acid, nickel(II) salt, Valeric acid, normal and ZINC05955167.

Notably, providing an adequate amount of lactic acid, along with very small amounts of butyric and/or valeric acids, produces a synergistic attractant effect. In particular, a very small amount of butyric acid or valeric acid, in combination with an adequate amount of lactic acid, renders the combination substantially more attractive to bed bugs than would be expected based on the individual attractive effects of the discrete chemicals.

In some embodiments, the lure-composition includes bed bug attracting amounts of 1-octen-3-ol (octenol). Octenol (CAS #3391-86-4) is mushroom alcohol, with a chemical formula C.sub.8H.sub.16O. Octenol is also called 1-Octen-3-ol (natural), 1-Okten-3-ol [Czech], 1-Vinylhexanol, 3-Hydroxy-1-octene, 3-Octenol, 3391-86-4, 50999-79-6, Al3-28627, Amyl vinyl carbinol, Amylvinylcarbinol, BRN 1744110, EINECS 222-226-0, EPA Pesticide Chemical Code 069037, FEMA No. 2805, Matsuica alcohol, Matsutake alcohol, Matsutake alcohol [Japanese], NSC 87563, NSC87563, Oct-1-en-3-ol, Oct-1-ene-3-ol, Pentyl vinyl carbinol, and Pentylvinylcarbinol and Vinyl amyl carbine. In the present invention, R-(−)-1-octen-3-ol, which is a single isomer from the racemic mixture, is also operable. Racemic octenol (CAS #3687-48-7) is also known as EPA Pesticide Chemical Code 069038.

In some embodiments, the lure composition includes bed bug attracting amounts of a sulfide. Specifically, “sulfide” is any compound dontaining at least one C-S group. Particular sulfides for use in the present invention will contain between 1 and 10 carbon atoms, inclusive between 1 and 3 sulfur atoms, inclusive. Particular aliphatic sulfides for use in the present invention include carbon disulfide, dimethyl sulfide, diethyl sulfide, dimethyl disulfide, diethyl disulfide, methyl propyl disulfide, ethyl vinyl sulfide, dimethyl sulfoxide and dimethyl trisulfide. A specific sulfide is carbon disulfide. Another specific sulfide is dimethyl disulfide. Another specific sulfide is dimethyl sulfoxide.

In some embodiments, the lure composition may include bed bug attracting amounts of a ketone. Specifically, “ketone” is any compound containing one or more -C(C.dbd.0)C- groups. Particular ketones for use in the present invention will have between 3-10 carbon atoms, inclusive. More specifically, ketone can be acetone, butone, 2-pentanone, 2-hexanone, 2-heptanone, 3-pentanone, 3-hexanone, 3-heptanone, 4-heptanone, 5-nonanone, 3-methyl-2-butanone, 4-methyl-2-pentanone, 3-penten-2-one, 3-buten-2-one, 3-hydroxy-2-butanone, 2,3-butanedione or 2,4-pentanedione. A specific ketone is acetone. Another specific ketone is butanone. Another specific ketone is 2-pentanone.

As is well understood in the art, compositions of the lure may include one or more compounds that have one or more chiral centers. Such compounds may exist and be isolated as optically active and racemic forms. Some compounds may exhibit polymorphism. It is to be understood that the present invention may encompass any racemic, optically-active, polymorphic, or stereoisomeric form, or mixtures thereof, of a compound of the invention, that possesses the useful properties described herein, it being well known in the art how to prepare optically active forms (for example, by resolution of the racemic form by recrystallization techniques, by synthesis, from optically-active starting materials, by chiral synthesis, by chromatographic separation using a chiral stationary phase, or using other processes which are well known in the art). Also it will be appreciated that substitution of lure compound stereoisomers may be highly desirable for effecting volatility properties. Thus, reference to a material as a compound having a central nucleus of a stated formula may include any compound that does not alter the bond structure of the specified formula.

According to various embodiments of the invention, a lure composition may be provided in any of a number of forms, solutions or carriers. For example, salts of any of L-lactic acid, propionic acid, butyric acid or valeric acid may be used. Acceptable salts may be obtained using standard procedures well known in the art. For example, alkali metal (for example, sodium, potassium or lithium) or alkaline earth metal (for example, calcium) salts of carboxylic acids can be made. Thus, the attractant lure composition may be employed in any formulation suitable for dispensing effective amounts of attractant compounds.

Lure compositions according to embodiments of the invention generally will be provided in formulations comprising a carrier containing the attractant compounds. For example, suitable lure compositions may be suspended in an aqueous solution or in a gel matrix, or may be provided as a solid, as a liquid, or in compressed gas form.

As one example of a suitable carrier, a gel matrix carrier can be a hydrolyzed protein gel material such as gelatin or a polysaccharide gel as disclosed by Williams in U.S. Pat. No. 6,790,436 in 2004. Another example carrier is a cooled paraffin wax and octenol solution mixed with salts of L-lactic acid, proprionic acid, butyric acid, and valeric acid. The attractant lure compounds may also be volatized from the liquid state directly from a wicking material with release rates controlled by head space and orifice size of a container.

The lure composition formulations may be placed in any suitable container or device for dispensing the attractant compound and trapping bed bugs. For example, the formulations can be placed on a pitfall trap type of dispensing device 1, as shown in the drawing FIGURE, to provide evaporation of the lure composition from a porous medium or wax-like medium containing the lure composition and positioned within the dispensing device. For enhanced emission of vapors from the lure composition, in some embodiments of the invention a suitable device may include a heat source 8, such as a resistance heater, a smoldering element, an exothermic chemical composition, or equivalent electrical or chemical means for maintaining an emission temperature, adjacent or proximate to the lure composition, of at least about normal human body temperature. In select embodiments a suitable device includes electrical or chemical means for maintaining the emission temperature within a range of about 96 deg F. to about 122 deg F. In some embodiments of the invention, a suitable device may include a compressed gas canister 9, a smoldering element, a reactive chemical composition, or other means for producing carbon dioxide in excess of normal atmospheric concentrations. In some embodiments of the invention, a suitable device may emit carbon dioxide to mimic normal human respiration. In select embodiments of the invention, a suitable device may emit carbon dioxide at concentrations within a range from about 700 ppm to about 50,000 ppm, at a rate between about 5 ml/min to about 400 ml/min.

As shown, a climb-up type pitfall trap 1, usable in embodiments of the invention, can include a rough exterior surface 2 that makes contact with the surrounding environment, such as a floor or a counter surface. The exterior surface 2 provides an upward sloping climbing wall that enables bed bugs to reach the pitfall precipice 3 at the top of the trap 1. The precipice 3 is a narrow surface that connects the exterior surface 2 to a smooth, slippery interior surface 4. The smooth interior surface 4 slopes down from the precipice 3 into a receptacle 5, which is defined by the interior surface 4 and by a smooth, upwardly conical sloped retaining surface 6. The smooth retaining surface 6 extends upward to a center stage 7. The center stage 7 provides a supporting surface for placement of a lure composition 10, according to embodiments of the present invention.

It should be appreciated that a pitfall trap 1 that is not provided with a retaining wall 6 or a center stage 7 may still be provided with attractants and lures by placing the sensory attractants and lures in the environment enclosed within the interior surface 4.

As discussed above, the pitfall trap 1 may also be provided with sensory attractants and lures on the center stage 7, such as a heat source 8 and a carbon dioxide source 9. The heat source 8 and the carbon dioxide source 9 generate or emit heat and carbon diox-ide, respectively, both of which mimic a human body to attract bed bugs and the like. Preferably, the heat source 8, the carbon dioxide source 9 and the chemical composition 10 are all placed proximate one another to compose a lure arrangement 11, from which the emissions of each component drift in approximately equal proportion and direction throughout the environment.

A method of using the monitoring climb-up trap for attracting and capturing bed bugs and the like includes the step of positioning a trap in an environment suspected or known to be infested by bed bugs or the like. An example of a suitable trap for bed bugs and the like, which can be utilized in conjunction with a chemical lure composition according to embodiments of the present invention, is disclosed in U.S. patent application Ser. No. 12/327,856 to McKnight, which is incorporated herein by reference. According to some aspects of the inventive method, a suitable trap may be placed on the floor in a bedroom known to be infested with bed bugs near or under a bed. The trap may be constructed with a central well in which the leg of a bed is set to capture bed bugs as they travel to or from the bed. Bed bugs are known, for example, to leave a bed during daylight hours only to return at night. The trap may also be placed on the floor of a cargo bay or passenger cabin of a ship or airplane suspected of containing bed bugs. The climb-up monitoring trap is loaded with the lure composition. The lure composition is activated thereby exposing the environment gaseous vapors from the lure composition. Bed bugs and the like will, then, be attracted towards the pitfall trap and captured therein upon crossing the precipice and becoming detained by the smooth interior surface in the receptacle. The contained bug can then be disposed of in any number of ways.

In a particularly preferred embodiment of the present invention, a lure composition includes bed bug attracting amounts of a combination of L-lactic acid, propionic acid, butyric acid, valeric acid, and octenol in a specific ratio, which provides a synergistic effect for attracting bed bugs. In this preferred embodiment, the inventive lure composition consists essentially of 300 parts L-lactic acid, 100 parts propionic acid, 1 part butyric acid, 1 part valeric acid, and 100 parts R-octenol by weight, with an acceptable variance of 20% for each constituent. While acetone and dimethyl disulfide may also be present, for example, 3000 parts acetone, and 30 parts dimethyl disulfide, these constituents are not presently believed essential to the synergism of the preferred composition. The synergistic effect is understood to reside in the very low concentrations of butyric and valeric acid required to enhance attraction of bed bugs, in the presence of an adequate amount of L-lactic acid.

The foregoing description of the present invention has been presented for the purpose of illustration and description. It is not intended to be exhaustive as to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular uses contemplated. It is intended that the scope of the present invention be defined by the claims appended hereto.

What is claimed is:

1. A bed bug lure composition consisting essentially of bed bug (Cimex lectularius or Cimex hemipterus) attracting amounts of:
1-octen-3-ol;
lactic acid; and
at least one of: propionic acid, butyric acid, valeric acid, or an acceptable salt thereof.

2. A composition as claimed in claim 1, comprising at least two of propionic acid, butyric acid, valeric acid, or acceptable salts thereof.

3. A composition as claimed in claim 1, consisting essentially of about 300 parts L-lactic acid, about 100 parts propionic acid, about 1 part butyric acid, about 1 part valeric acid, and about 100 parts R-octenol.

4. A composition as claimed in claim 3, further comprising about 3000 parts acetone, and about 30 parts dimethyl disulfide.

5. A bed bug (Cimex lectularius or Cimex hemipterus) trapping apparatus comprising:
an electrical or chemical means for maintaining a temperature of at least about normal human body temperature;
a means for emitting carbon dioxide in greater than normal atmospheric concentrations; and
a lure composition consisting essentially of bed bug attracting amounts of: 1-octen-3-ol; lactic acid; and at least one of: propionic acid, butyric acid, valeric acid, or an acceptable salt thereof.

6. An apparatus as claimed in claim 5, wherein the lure composition comprises at least two of propionic acid, butyric acid, valeric acid, or acceptable salts thereof.

7. An apparatus as claimed in claim 5, wherein the lure composition consists essentially of about 300 parts L-lactic acid, about 100 parts propionic acid, about 1 part butyric acid, about 1 part valeric acid, and about 100 parts R-octenol.

8. An apparatus as claimed in claim 7, wherein the lure composition further comprises about 3000 parts acetone, and about 30 parts dimethyl disulfide.

9. A method for monitoring for the presence of bed bugs (Cimex lectularius or Cimex hemipterus) using an intercepting device, which comprises an upstanding, exterior climbable surface that bed bugs can climb and a pitfall trap disposed inwardly of the climbable exterior surface, wherein bed bugs are trapped as a result of being unable to climb out, the method comprising:
installing in the intercepting device a lure composition consisting essentially of bed bug (Cimex lectularius or Cimex hemipterus) attracting amounts of:
1-octen-3-ol;
lactic acid; and
at least one of: propionic acid, butyric acid, valeric acid, or an acceptable salt thereof; and
placing the intercepting device in an area to be monitored.

10. A method as claimed in claim 9, further comprising:
emitting at least one of heat or carbon dioxide in proximity to the intercepting device.

11. A method as claimed in claim 9, wherein the lure composition consists essentially of about 300 parts L-lactic acid, about 100 parts propionic acid, about 1 part butyric acid, about 1 part valeric acid, and about 100 parts R-octenol.
